(19) United States
(12) Patent Application Publication
(10) Pub. No.: US 2013/0273313 A1
(43) Pub. Date: Oct. 17, 2013

(54) CERAMIC COATED RING AND PROCESS FOR APPLYING CERAMIC COATING

(71) Applicant: APPLIED MATERIALS, INC., Santa Clara, CA (US)

(72) Inventors: Jennifer Y. Sun, Mountain View, CA (US); Ren-Guan Duan, Fremont, CA (US); Dmitry Lubomirsky, Cupertino, CA (US)

(73) Assignee: Applied Materials, Inc., Santa Clara, CA (US)

(21) Appl. No.: 13/745,592

(22) Filed: Jan. 18, 2013

Related U.S. Application Data
(60) Provisional application No. 61/624,108, filed on Apr. 13, 2012.

(51) Int. Cl. C03C 17/23; C03C 17/00

(52) U.S. Cl. CPC C03C 17/23; C03C 17/003
USPC 428/137; 427/292; 427/453

(57) ABSTRACT

To manufacture a ceramic coated article, at least one surface of a quartz substrate having a ring shape is roughened to a roughness of approximately 100 micro-inches (μin) to approximately 300 μin. The quartz substrate is then coated with a ceramic coating comprising a yttrium containing oxide. The quartz substrate is then polished.

### RELATED APPLICATIONS

This patent application claims the benefit under 35 U.S.C. §119(e) of U.S. Provisional Application No. 61/624,108, filed Apr. 13, 2012.

### TECHNICAL FIELD

Embodiments of the present invention relate, in general, to ceramic coated articles and to a process for applying a ceramic coating to a substrate having a ring shape.

### BACKGROUND

In the semiconductor industry, devices are fabricated by a number of manufacturing processes producing structures of an ever-decreasing size. Some manufacturing processes such as plasma etch and plasma clean processes expose a substrate to a high-speed stream of plasma to etch or clean the substrate. The plasma may be highly corrosive, and may corrode processing chambers and other surfaces that are exposed to the plasma. This corrosion may generate particles, which frequently contaminate the substrate that is being processed, contributing to device defects.

As device geometries shrink, susceptibility to defects increases, and particle contaminant requirements become more stringent. Accordingly, as device geometries shrink, allowable levels of particle contamination may be reduced. To minimize particle contamination introduced by plasma etch and/or plasma clean processes, chamber materials have been developed that are resistant to plasmas. Examples of such plasma resistant materials include quartz and ceramics composed of Al₂O₃, AlN, SiC, Y₂O₃, and ZrO₂. Different materials provide different material properties, such as plasma resistance, rigidity, flexural strength, thermal shock resistance, and so on. Also, different materials have different material costs. Accordingly, some materials have superior plasma resistance, other materials have lower costs, and still other materials have superior flexural strength and/or thermal shock resistance.

### SUMMARY

In one embodiment, a ceramic coated article includes a quartz substrate and a ceramic coating on the quartz substrate. To manufacture the ceramic coated article, at least one surface of a quartz substrate is roughened to a roughness of approximately 100 micro-inches (μin) to approximately 300 μin. The quartz substrate is then coated with a ceramic coating comprising a yttrium containing oxide. The quartz substrate is then polished.

### BRIEF DESCRIPTION OF THE DRAWINGS

The present invention is illustrated by way of example, and not by way of limitation, in the figures of the accompanying drawings in which like references indicate similar elements. It should be noted that different references to “an” or “one” embodiment in this disclosure are not necessarily to the same embodiment, and such references mean at least one.

FIG. 1 illustrates an exemplary architecture of a manufacturing system, in accordance with one embodiment of the present invention;

FIG. 2 is a flow chart showing a process for manufacturing a coated ceramic article, in accordance with embodiments of the present invention;

FIG. 3 shows cross sectional side views of an article during different stages of a manufacturing process, in accordance with embodiments of the present invention;

FIG. 4A illustrates a top view of a ring used in a plasma etch reactor, in accordance with one embodiment of the present invention.

FIG. 4B illustrates a cross-sectional side view of a plasma etch reactor, in accordance with one embodiment of the present invention.

FIG. 5 is a graph showing wafer edge etch depth comparison between wafers processed using a conventional quartz ring and a ceramic coated quartz ring.

### DETAILED DESCRIPTION OF EMBODIMENTS

Embodiments of the invention are directed to a process for coating a substrate having a ring shape with a ceramic coating, and to an article created using such a coating process. In one embodiment, a substrate having a ring shape is roughened, coated with a ceramic coating and polished. Parameters for the roughening, the coating and the polishing may be optimized to maximize an adhesion strength of the ceramic coating to the substrate, and thus to reduce future delamination of the ceramic coating from the substrate.

The ceramic coating of the article may be highly resistant to plasma etching, and the substrate may have superior mechanical properties such as a high flexural strength and a high thermal shock resistance. For example, quartz (e.g., fused quartz) has a high thermo-mechanical strength and relatively low expense, but has a relatively low plasma resistance. In contrast, Y₂O₃ containing ceramics have enhanced plasma resistance and increased expense, but have a relatively low thermo-mechanical strength. Accordingly, the article may have the advantageous properties of a substance (e.g., quartz) and the advantageous properties of a ceramic coating (e.g., a Y₂O₃ containing ceramic), without the weaknesses of either substance. Performance properties of the coated ceramic article may include a relatively high thermal capability (e.g., ability to withstand operating temperatures of up to approximately 1000° C.), a relatively long lifespan, low on-wafer particle and metal contamination, and a stable electrostatic chuck (ESC) leakage current performance (e.g., by blocking the formation of AlF at the article).

When the terms “about” and “approximately” are used herein, these are intended to mean that the nominal value presented is precise within ±10%. Note also that some embodiments are described herein with reference to rings used in plasma etchers for semiconductor manufacturing. However, it should be understood that such plasma etchers may also be used to manufacture micro-electro-mechanical systems (MEMS)) devices. Additionally, the articles described herein may be other structures that are exposed to plasma. For example, the articles may be walls, bases, gas distribution plates, shower heads, substrate holding frames, etc. of a plasma etcher, a plasma cleaner, a plasma propulsion system, and so forth.

Moreover, embodiments are described herein with reference to ceramic coated rings and ceramic coated quartz that may cause reduced particle contamination when used in a process chamber for plasma rich processes. However, it should be understood that the ceramic coated rings and ceramic coated quartz discussed herein may also provide reduced particle contamination when used in process chambers for other processes such as plasma enhanced chemical vapor deposition (PECVD), plasma enhanced physical vapor deposition (PEPVD), and plasma enhanced atomic layer deposition (PEALD). Additionally, it should be understood that the ceramic coated rings and ceramic coated quartz discussed herein may be used in non-plasma etch reactors, non-plasma cleaners, chemical vapor deposition (CVD) chambers, physical vapor deposition (PVD) chambers, and so forth.

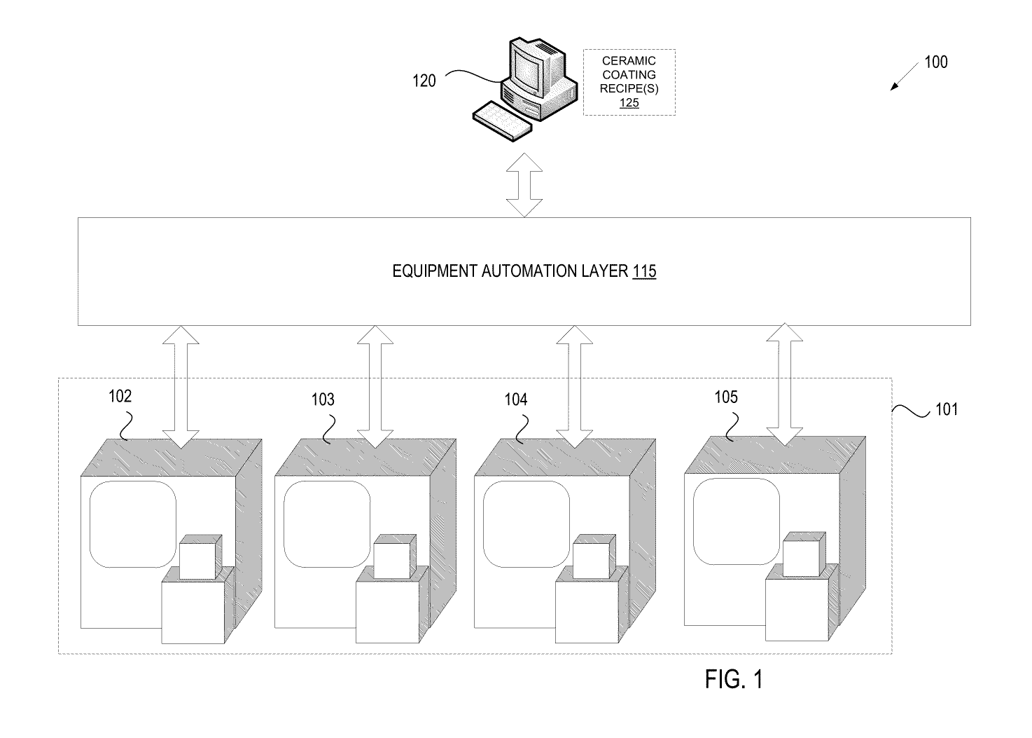

FIG. 1 illustrates an exemplary architecture of a manufacturing system 100, in accordance with embodiments of the present invention. The manufacturing system 100 may be a ceramics manufacturing system. In one embodiment, the manufacturing system 100 includes processing equipment 101 connected to an equipment automation layer 115. The processing equipment 101 may include a bead blaster 102, one or more wet cleaners 103, a ceramic coater 104 and/or one or more grinders 105. The manufacturing system 100 may further include one or more computing device 120 connected to the equipment automation layer 115. In alternative embodiments, the manufacturing system 100 may include more or fewer components. For example, the manufacturing system 100 may include manually operated (e.g., off-line) processing equipment 101 without the equipment automation layer 115 or the computing device 120.

Bead blaster 102 is a machine configured to roughen the surface of articles such as ceramic and quartz substrates. Bead blaster 102 may be a bead blasting cabinet, a hand held bead blaster, or other type of bead blaster. Bead blaster 102 may roughen a substrate by bombarding the substrate with beads or particles. In one embodiment, bead blaster 102 fires ceramic beads or particles at the substrate. The roughness achieved by the bead blaster 102 may be based on a force used to fire the beads, bead materials, bead sizes, distance of the bead blaster from the substrate, processing duration, and so forth. In one embodiment, the bead blaster uses a range of bead sizes to roughen the ceramic article.

In alternative embodiments, other types of surface rougheners than a bead blaster 102 may be used. For example, a motorized abrasive pad may be used to roughen the surface of ceramic substrates. A sander may rotate or vibrate the abrasive pad while the abrasive pad is pressed against a surface of the ceramic article. A roughness achieved by the abrasive pad may depend on an applied pressure, on a vibration or rotation rate and/or on a roughness of the abrasive pad.

Wet cleaners 103 are cleaning apparatuses that clean articles (e.g., ceramic articles and quartz articles) using a wet clean process. Wet cleaners 103 include wet baths filled with liquids, in which the substrate is immersed to clean the substrate. Wet cleaners 103 may agitate the wet bath using ultrasonic waves during cleaning to improve a cleaning efficacy. This is referred to herein as sonicating the wet bath.

In one embodiment, wet cleaners 103 include a first wet cleaner that cleans the ceramic articles using a bath of de-ionized (DI) water and a second wet cleaner that cleans the ceramic articles using a bath of acetone. Both wet cleaners 103 may sonicate the baths during cleaning processes. The wet cleaners 103 may clean the ceramic substrate at multiple stages during processing. For example, wet cleaners 103 may clean an article after a substrate has been roughened, after a ceramic coating has been applied to the substrate, after the article has been used in processing, and so forth.

In other embodiments, alternative types of cleaners such as dry cleaners may be used to clean the articles. Dry cleaners may clean articles by applying heat, by applying gas, by applying plasma, and so forth.

Ceramic coater 104 is a machine configured to apply a ceramic coating to the surface of a substrate. In one embodiment, ceramic coater 104 is a plasma sprayer that plasma sprays a ceramic coating onto the ceramic substrate. In alternative embodiments, the ceramic coater 104 may apply other thermal spraying techniques such as detonation spraying, wire arc spraying, high velocity oxygen fuel (HVOF) spraying, flame spraying, warm spraying and cold spraying may be used. Additionally, ceramic coater 104 may perform other coating processes such as aerosol deposition, electroplating, physical vapor deposition (PVD) and chemical vapor deposition (CVD) may be used to form the ceramic coating.

Grinders 105 are machines having an abrasive disk that grinds and/or polishes a surface of the article. The grinders 105 may include a polishing/grinding system such as a rough lapping station, a chemical mechanical planarization (CMP) device, and so forth. The grinders 105 may include a platen that holds a substrate and an abrasive disk or polishing pad that is pressed against the substrate while being rotated. These grinders 105 grind a surface of the ceramic coating to decrease a roughness of the ceramic coating and/or to reduce a thickness of the ceramic coating. The grinders 105 may grind/polish the ceramic coating in multiple steps, where each step uses an abrasive pad with a slightly different roughness and/or a different slurry (e.g., if CMP is used). For example, a first abrasive pad with a high roughness may be used to quickly grind down the ceramic coating to a desired thickness, and a second abrasive pad with a low roughness may be used to polish the ceramic coating to a desired roughness.

The grinders 105 may additionally include an angle grinder that grinds the ceramic coating at an angle. The angle grinder has an abrasive disk or pad that is held at an angle to the ceramic substrate. The angle grinder can trim the ceramic coating, and generate chamfers, rounded edges or other sloped transitions between a ceramic coating and a ceramic substrate.

The equipment automation layer 115 may interconnect some or all of the manufacturing machines 101 with computing devices 120, with other manufacturing machines, with metrology tools and/or other devices. The equipment automation layer 115 may include a network (e.g., a location area network (LAN)), routers, gateways, servers, data stores, and so on. Manufacturing machines 101 may connect to the equipment automation layer 115 via a SEMI Equipment Communications Standard/Generic Equipment Model (SECS/GEM) interface, via an Ethernet interface, and/or via other interfaces. In one embodiment, the equipment automation layer 115 enables process data (e.g., data collected by manufacturing machines 101 during a process run) to be stored in a data store (not shown). In an alternative embodiment, the computing device 120 connects directly to one or more of the manufacturing machines 101.

In one embodiment, some or all manufacturing machines 101 include a programmable controller that can load, store and execute process recipes. The programmable controller may control temperature settings, gas and/or vacuum settings, time settings, etc. of manufacturing machines 101. The programmable controller may include a main memory (e.g., read-only memory (ROM), flash memory, dynamic random access memory (DRAM), static random access memory (SRAM), etc.), and/or a secondary memory (e.g., a data storage device such as a disk drive). The main memory and/or secondary memory may store instructions for performing heat treatment processes described herein.

The programmable controller may also include a processing device coupled to the main memory and/or secondary memory (e.g., via a bus) to execute the instructions. The processing device may be a general-purpose processing device such as a microprocessor, central processing unit, or the like. The processing device may also be a special-purpose processing device such as an application specific integrated circuit (ASIC), a field programmable gate array (FPGA), a digital signal processor (DSP), network processor, or the like. In one embodiment, programmable controller is a programmable logic controller (PLC).

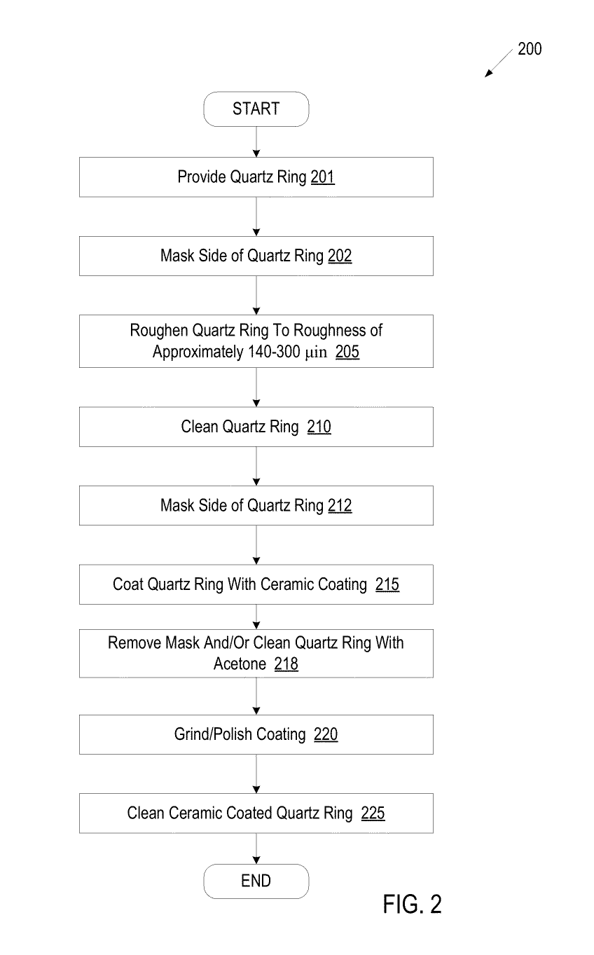

In one embodiment, the manufacturing machines 101 are programmed to execute recipes that will cause the manufacturing machines to roughen a substrate, clean a substrate and/or ceramic article, coat a ceramic article and/or machine (e.g., grind or polish) a ceramic article. In one embodiment, the manufacturing machines 101 are programmed to execute recipes that perform operations of a multi-step process for manufacturing a ceramic coated article, as described with reference to FIG. 2. The computing device 120 may store one or more ceramic coating recipes 125 that can be downloaded to the manufacturing machines 101 to cause the manufacturing machines 101 to manufacture ceramic coated articles in accordance with embodiments of the present invention.

FIG. 2 is a flow chart showing a process 200 for manufacturing a coated ceramic article, in accordance with embodiments of the present invention. The operations of process 200 may be performed by various manufacturing machines, as set forth in FIG. 1.

At block 201, a quartz substrate having a ring shape is provided. In alternative embodiments, the substrate may be a silicon carbide ring or a silicon ring. Also, a quartz substrate having a shape other than a ring may be provided. In one embodiment, the quartz substrate has a thickness of approximately 0.55-0.62 inches.

At block 202, the provided substrate is masked to cover portions of the substrate that will not be roughened. Any region that will not ultimately be coated with a ceramic coating may be masked. In one embodiment, a hard mask (e.g., a metal mask) is used to mask the region. In one embodiment, a side of the quartz ring is masked. The masked side of the quartz ring may correspond to an inner side of the ring.

At block 205 of process 200, the quartz ring is roughened by a bead blaster (or other ceramic roughener). In one embodiment, the bead blaster uses beads (e.g., ceramic beads or salt beads) to blast the quartz ring. Ceramic beads may have a bead size of approximately 0.2-2 mm. In one embodiment, the ceramic beads have a size range of approximately 0.2-2 mm. The bead blaster may bead blast the quartz ring with an air pressure of approximately 30-90 psi and a working distance of approximately 50-150 mm, and the blasting angle to substrate should be about or slightly less than 90 degree. The bead blaster may roughen exposed portions of the quartz ring (those portions not covered by the mask). In one embodiment, a top and an outer side of the quartz ring are roughened.

In one embodiment, a processed quartz ring has a post-blast roughness of approximately 100-300 μin. Roughening the quartz ring to an optimal roughness may improve adhesion strength of a ceramic coating to the quartz ring.

At block 210, the roughened quartz ring is cleaned. The quartz ring may be cleaned using one or more wet cleaners. Each wet cleaner may contain one or more wet baths with various liquids, such as deionized (DI) water and acetone. In one embodiment, a wet cleaner executes a cleaning recipe that cleans the quartz ring for 10 minutes in a DI water bath, while ultrasonically agitating the DI water bath with a frequency 10-100 kHz and power of up to 100%.

At block 212, the quartz ring is masked. Those portions of the quartz ring that were not roughened (e.g., the same potions that were previously masked) may be masked. In one embodiment, a soft mask is used to cover the portions that are not to be roughened. The soft mask may be, for example, a tape and/or polymer that is placed over the portions that will not be roughened.

At block 215, the roughened quartz ring is coated with a ceramic coating. Portions of the quartz ring that will be exposed to a plasma environment may be coated. In one embodiment, a plasma sprayer is used to plasma spray the ceramic coating onto the quartz ring.

The ceramic coating may be formed of Y₂O₃, Y₄Al₂O₉ (YAM), Y₃Al₅O₁₂ (YAG), or other yttria containing ceramics. The ceramic coating may be pure yttrium oxide (Y₂O₃) or a yttrium oxide containing solid solution that may be doped with one or more of ZrO₂, Al₂O₃, SiO₂, B₂O₃, Er₂O₃, Nd₂O₃, Nb₂O₅, CeO₂, Sm₂O₃, Yb₂O₃, or other oxides. In one embodiment, the ceramic coating is a high performance material (HPM) that is composed of a compound Y₄Al₂O₉ and a solid solution Y₂-xZrₓO₃ (Y2O3-ZrO2 solid solution).

In one embodiment, the ceramic coating is a yttrium oxide containing ceramic that is deposited on the ceramic substrate using a thermal spraying technique or plasma spraying technique. Thermal spraying techniques and plasma spraying techniques may melt materials (e.g., ceramic powders) and spray the melted materials onto the ceramic substrate. The thermally sprayed or plasma sprayed ceramic coating may have a thickness about 1-12 mil. The ceramic coating may have structural properties that are significantly different from those of the quartz ring.

In one embodiment, the ceramic coating is produced from Y₂O₃ powder. The ceramic coating may also be produced from a combination of Y₂O₃ powder and Al₂O₃. Alternatively, the ceramic coating may be a high performance material (HPM) ceramic composite produced from a mixture of a Y₂O₃ powder, ZrO₂ powder and Al₂O₃ powder. In one embodiment, the HPM ceramic composite contains 77% Y₂O₃, 15% ZrO₂ and 8% Al₂O₃. In another embodiment, the HPM ceramic composite contains 63% Y₂O₃, 23% ZrO₂ and 14% Al₂O₃. In still another embodiment, the HPM ceramic composite contains 55% Y₂O₃, 20% ZrO₂ and 25% Al₂O₃. Relative percentages may be in molar ratios. For example, the HPM ceramic may contain 77 mol % Y₂O₃, 15 mol % ZrO₂ and 8 mol% Al₂O₃. Other distributions of these ceramic powders may also be used for the HPM material.

In one embodiment, raw ceramic powders of Y₂O₃, Al₂O₃ and ZrO₂ are mixed together. These raw ceramic powders may have a purity of 99.9% or greater in one embodiment. The raw ceramic powders may be mixed using, for example, ball milling. The raw ceramic powders may have a powder size of approximately 100 nm-20 μm. In one embodiment, the raw ceramic powders have a powder size of approximately 5 μm. After the ceramic powders are mixed, they may be calcinated at a calcination temperature of approximately 1200-1600° C. (e.g., 1400° C. in one embodiment) and a calcination time of approximately 2-5 hours (e.g., 3 hours in one embodiment). The spray dried granular particle size for the mixed powder may have a size distribution of approximately 30 μm.

The mixed raw ceramic powders are sprayed onto the quartz ring. The quartz ring may be heated to a temperature of approximately 10-300° C. during the plasma spraying. In one embodiment, the quartz ring is heated to a temperature of approximately 25° C. In one embodiment, a plasma power of approximately 50-90 kilo-Watts (kW) is used to plasma spray the quartz ring, with a current of approximately 100-160 amps and a voltage of approximately 260-310 volts. In one embodiment, a power of 74 kW, a current of 130 amps and a voltage of 287 volts is used. In one embodiment, the ceramic powders are fed at a rate of 5-100 g/minute. The plasma sprayer may also use a plasma gas flow rate of 0-100 L/minute for Argon and/or Oxygen.

The plasma spray process may be performed in multiple spray passes. Passes may have a nozzle moving speed of approximately 600-3000 mm/second. For each pass, the angle of a plasma spray nozzle may change to maintain a relative angle to a surface that is being sprayed. For example, the plasma spray nozzle may be rotated to maintain an angle of approximately 45 degrees to approximately 90 degrees with the surface of the quartz ring being sprayed. In one embodiment, the plasma spray nozzle maintains a distance of approximately 60-150 mm from the surface being sprayed, that are applied to create a ceramic coating having a thickness of approximately 1-12 mil. Each pass may deposit a thickness of up to approximately 100 μm.

The ceramic coating may have a porosity of approximately 0.5-5% (e.g., less than approximately 5% in one embodiment), a hardness of approximately 4-8 gigapascals (GPa) (e.g., greater than approximately 4 GPa in one embodiment), and a thermal shock resistance of approximately 200° C. (e.g., greater than approximately 120° C. in one embodiment). Additionally, the ceramic coating may have an adhesion strength of approximately 4-20 MPa (e.g., greater than approximately 14 MPa in one embodiment). Adhesion strength may be determined by applying a force (e.g., measured in megapascals) to the ceramic coating until the ceramic coating peels off from the ceramic substrate.

At block 218, the mask is removed from the quartz substrate. The mask may leave a polymer residue on the quartz after removal of the mask. Accordingly, the quartz ring may be cleaned with acetone to remove the residue. In one embodiment, the region where the mask was located is cleaned without cleaning a remainder of the quartz ring. Alternatively, an entirety of the quartz ring may be cleaned (e.g., using a wet cleaner having an acetone bath).

At block 220, the ceramic coating is machined. The machining may include trimming the ceramic coating on an inner side of the quartz ring. The machining may additionally include grinding, lapping and/or polishing the ceramic coating to reduce a thickness of the ceramic coating and/or to reduce a roughness of the ceramic coating. The ceramic coated quartz ring may be used as a chamber component in a chamber for a plasma etcher used to perform a conductor etch. In one embodiment, the ceramic coating has a post-polish thickness of approximately 1-10 mil and a post-polish roughness of approximately 6-12 μin (e.g., 8 μin in one embodiment).

At block 225, the ceramic coated quartz ring is cleaned. The cleaning may be performed using one or more wet cleaners. In one embodiment, a first wet cleaner executes a cleaning recipe that cleans the ceramic article for 10 minutes in a DI water bath, while ultrasonically agitating the DI water bath with a frequency of approximately 10-100 kHz and power of up to 100%. In one embodiment, a second wet cleaner executes a cleaning recipe that cleans the ceramic article for about 5 minutes in an acetone bath. The ceramic substrate may then be cleaned with the first wet cleaner a second time.

After cleaning, the ceramic article may have a laser particle count of approximately 100,000 particles sized 0.2 μm or larger per square centimeter. Measured parameters that represent particle count are a tape peel test particle count and a liquid particle count (LPC). The tape test may be performed by attaching an adhesive tape to the ceramic coating, peeling the tape off, and counting a number of particles that adhere to the tape. The LPC may be determined by placing the ceramic article in a water bath (e.g., a de-ionized (DI) water bath) and sonicating the water bath. A number of particles that come off in the solution may then be counted using, for example, a laser counter.

In one embodiment, the ceramic substrate/article is automatically loaded into manufacturing machines that perform one or more of operations 205-225 by loaders.

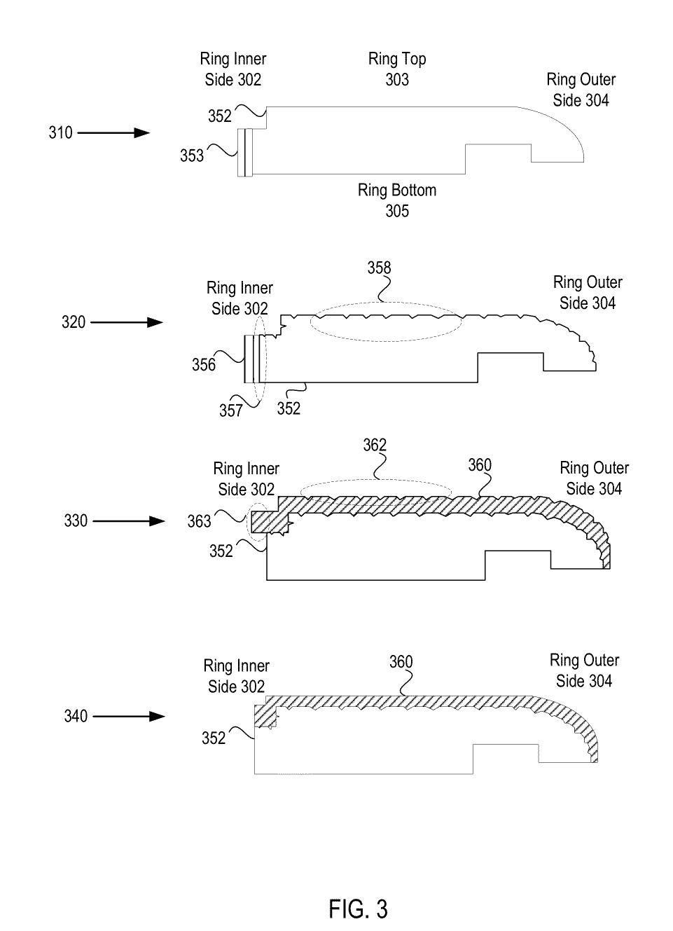

FIG. 3 shows cross sectional side views 310-340 of a quartz ring during different stages of a manufacturing process, in accordance with embodiments of the present invention. In one embodiment, the cross sectional side views correspond to a state of the quartz ring during different stages of manufacturing process 200. As shown, the quartz ring has an inner side 302 and an outer side 304. The quartz ring also has a top 303 and a bottom 305. The inner side 302 may be approximately perpendicular to the ring top 303, and may be notched to receive another process chamber component (e.g., another ring). The outer side 304 may be rounded.

Side view 310 shows a hard mask 353 disposed over a protected portion of a provided quartz ring 352 (or ring of silicon carbide or silicon). As shown, the hard mask 353 is positioned over a side wall of the quartz substrate at the inner side 302. Side view 310 shows a state of a quartz ring 352 after completion of block 202 of method 200. The hard mask 353 may prevent the protected portion from becoming roughened during bead blasting.

Side view 320 shows the quartz ring 352 after bead blasting has been performed. The quartz ring 352 has a roughened surface 358, corresponding to a portion of the quartz ring that was not protected during the bead blasting. The quartz ring 352 additionally has a smooth surface 357 corresponding to a portion of the quartz ring 352 that has not been roughened. As shown, a soft mask 356 is disposed on the quartz ring 352 over the smooth surface 357 after the quartz ring 352 has been roughened. The soft mask 356 may be used to cover a same region of the quartz ring 352 that was previously protected by the hard mask 353. Side view 320 shows a state of the quartz ring after completion of block 212.

Side view 330 shows a ceramic coating 360 over quartz ring 352. In one embodiment, the ceramic coating is a HPM ceramic composite having Y₄Al₂O₉ and Y₂-xZrₓO₃. Alternatively, the ceramic coating may be YAG or yttria. As shown, the ceramic coating 360 has a rough surface 362. This rough surface 312 may be a source of particle contamination when the ceramic coated quartz ring is used in processing. Additionally, the ceramic coating may have a lip 363 and/or rough edges where the soft mask 356 had been. This lip 363 may cause the ceramic coating 360 to peel away from the quartz ring 352 during processing. Additionally, this lip may be a source of particle contamination. Side view 330 shows a state of the ceramic coated quartz ring after completion of block 215.

Side view 340 shows the ceramic coating 360 over the quartz ring 352 after edges of the ceramic coating 360 have been trimmed and after the ceramic coating 360 has been ground and polished. An angle of a grinder/polisher may be adjusted during processing to grind and/or polish the rounded outer side 304 of the ceramic coated quartz ring. Side view 340 shows a state of the ceramic article after completion of block 225. As shown, the rough surface 362 of the ceramic coating 360 has been smoothed, and a thickness of the ceramic coating 360 has been reduced.

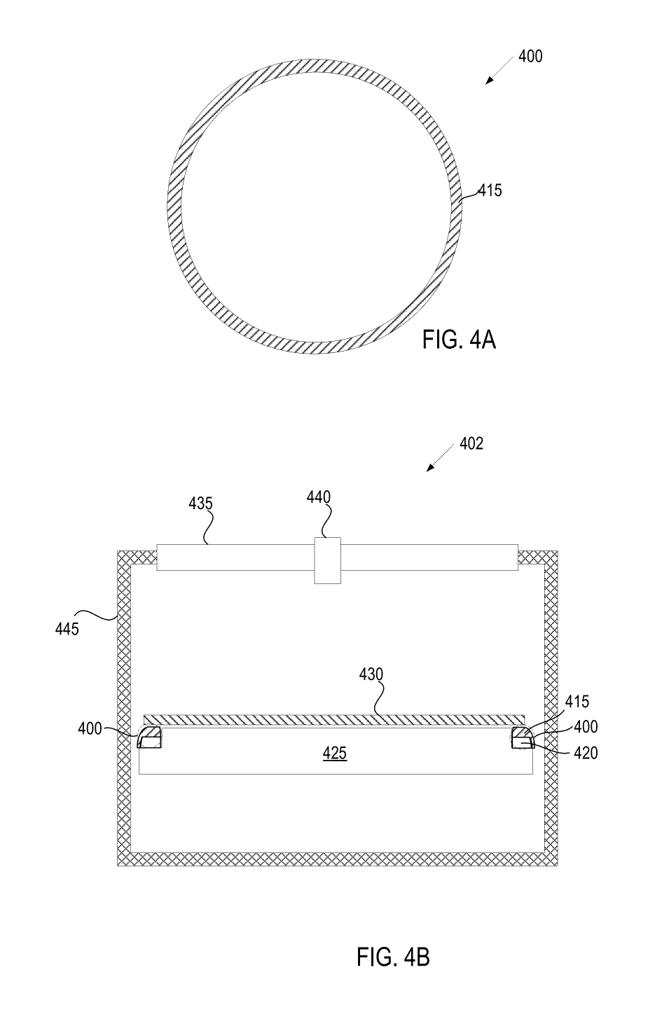

FIG. 4A illustrates a top view showing a top of a ceramic coated quartz ring 400 for an etcher, in accordance with one embodiment of the present invention. FIG. 4B illustrates a cross sectional side view of a plasma etcher 402 incorporating the ceramic coated quartz ring 400 of FIG. 4A, in accordance with one embodiment of the present invention. As shown, the ring 400 is composed of a quartz substrate 420 and a ceramic coating 415 over portions of the quartz substrate 420.

The plasma etcher 402 includes a chamber 445 with a lid 435 at a top of the chamber 445. A nozzle 440 is inserted into the lid 435. The ceramic coated quartz ring 400 rests on an electrostatic chuck (ESC) 425 that is designed to hold a wafer 430 during processing. The ceramic coated quartz ring 400 covers a portion of the ESC 425 that would otherwise be exposed to plasma. The ESC 425 may be composed of aluminum, AlN, Al₂O₃ and/or other materials. For example, a typical ESC includes an aluminum base and a ceramic electrostatic puck composed of AlN or Al₂O₃. Accordingly, if a fluoride containing plasma is used, the fluoride may react with the aluminum to form aluminum fluoride. This can negatively impact part yield. The ring 400 covers the aluminum portion of the ESC 425 and prevents the aluminum portion of the ESC 425 from reacting with the plasma.

Traditional rings used to protect the ESC 425 are pure quartz. Conventional pure quartz rings have a high erosion rate when exposed to plasma. As the quartz ring is eroded, an aluminum portion of the ESC 425 may be exposed (thus causing, for example, the formation of AlFₓ), and a ring shape may change. This may have a significant impact of wafer edge critical dimension performance such as etch depth and depth non-uniformity. Thus, conventional protective rings have a short life time, which causes plasma etchers to be taken offline frequently to replace the rings.

The ceramic coated rings described in embodiments of the present invention have significantly improved plasma erosion resistance, and thus improved life spans as compared to traditional rings. For example, the erosion rate of a conventional quartz ring may be over 30 times faster than an HPM or Y₂O₃ coated quartz ring, and about 15 times faster than a YAG coated quartz ring for CF₄/CHF₃ chemistries. Similarly, the erosion rate of a conventional quartz ring may be over 46 times faster than an HPM coated quartz ring, 28 times faster than a Y₂O₃ coated quartz ring and about 11 times faster than a YAG coated quartz ring for Cl₂/HBr chemistries. The erosion rate of a conventional quartz ring may be over 10 times faster than an HPM coated quartz ring, and 6 times faster than a Y₂O₃ or YAG coated quartz ring for NF₃/HBr chemistries. Similarly, the erosion rate of a conventional quartz ring may be over 18 times faster than an HPM coated quartz ring, 24 times faster than a Y₂O₃ coated quartz ring and 12 times faster than a YAG coated quartz ring for COS chemistries. The erosion rate of a conventional quartz ring may be over 48 times faster than an YAG coated quartz ring, and 36 times faster than a Y₂O₃ or YAG coated quartz ring for H₂ chemistries.

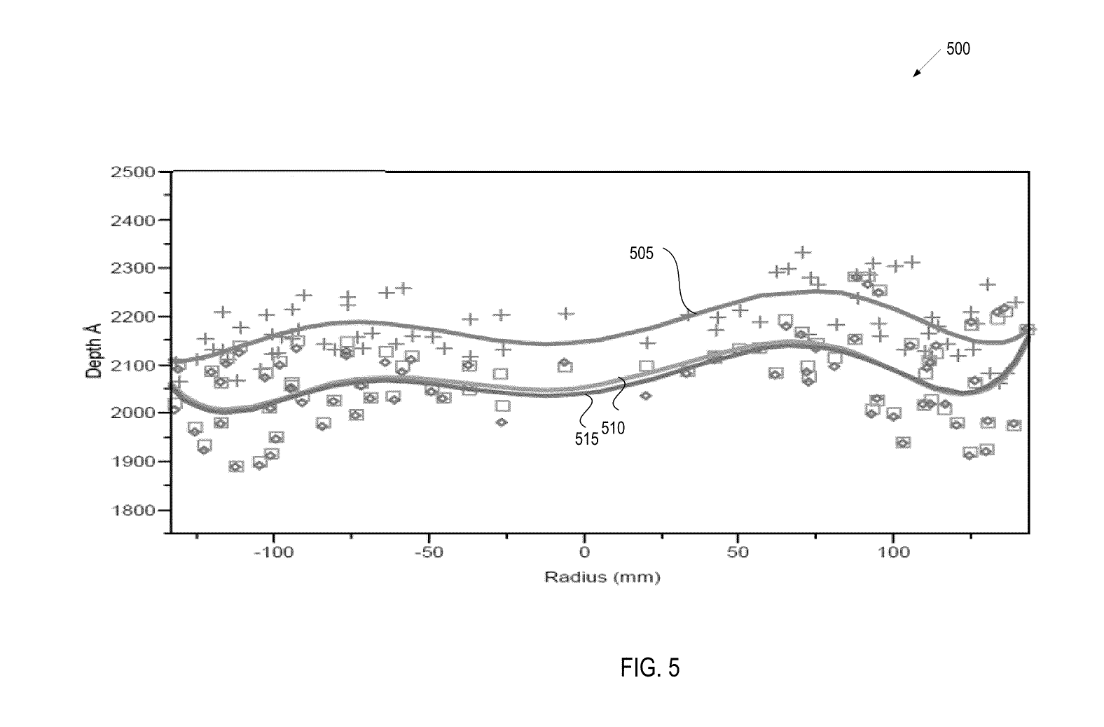

FIG. 5 is a graph showing a wafer edge etch depth comparison between wafers processed using aged conventional quartz rings 510 and 515 and wafers processed using a ceramic coated quartz ring 505. As shown, the edge depth of the processed wafer increased by approximately 11 nm and the depth 3 sigma non-uniformity decreased approximately 4% with use of the ceramic coated quartz ring 505 in comparison to the conventional solid quartz rings 510, 515.

The preceding description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Reference throughout this specification to “one embodiment” or “an embodiment” means that a particular feature, structure, or characteristic described in connection with the embodiment is included in at least one embodiment. Thus, the appearances of the phrase “in one embodiment” or “in an embodiment” in various places throughout this specification are not necessarily all referring to the same embodiment. In addition, the term “or” is intended to mean an inclusive “or” rather than an exclusive “or.”

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent to those of skill in the art upon reading and understanding the above description. The scope of the invention should, therefore, be determined with reference to the appended claims, along with the full scope of equivalents to which such claims are entitled.

What is claimed is:

1. A method of manufacturing an article, comprising:
roughening at least one surface of a quartz substrate having a ring shape to a roughness of approximately 100 micro-inches (μin) to approximately 300 μin;
coating the at least one surface of the quartz substrate with a ceramic coating comprising a yttrium containing oxide; and
polishing the ceramic coating.

2. The method of claim 1, further comprising:
masking a side of the quartz substrate with a first mask prior to the roughening, wherein the masked side is not roughened;
masking the side of the quartz substrate with a second mask prior to the coating, wherein the masked side is not coated; and
removing the second mask and cleaning the side of the quartz substrate with acetone prior to the polishing.

3. The method of claim 2, wherein the first mask is a hard mask, the second mask is a soft mask, and the masked side of the quartz substrate corresponds to an inner side of the quartz substrate's ring shape.

4. The method of claim 1, wherein the ceramic coating has a thickness of approximately 1-12 mil prior to the polishing and a thickness of approximately 1-10 mil after the polishing.

5. The method of claim 1, wherein coating the quartz substrate comprises:
heating the quartz substrate to a temperature of approximately 10° C. to 300° C.; and
plasma spraying the quartz substrate using a plasma spray power of approximately 50 kW to 90 kW.

6. The method of claim 1, wherein the quartz substrate is a process chamber component for covering a portion of an electrostatic chuck used in a plasma etch reactor.

7. The method of claim 1, wherein the ceramic coating is selected from a list consisting of Y₂O₃, Y₃Al₅O₁₂ (YAG), and a compound comprising Y₄Al₂O₉ (YAM) and a solid solution of Y₂-xZrₓO₃

8. An article comprising a quartz substrate having a ring shape and a ceramic coating, the article having been prepared by a process comprising:
roughening at least one surface of the quartz substrate having the ring shape to a roughness of approximately 100 micro-inches (μin) to approximately 300 μin;
coating the at least one surface of the quartz substrate with the ceramic coating, wherein the ceramic coating comprises a yttrium containing oxide; and
polishing the ceramic coating.

9. The article of claim 8, the process further comprising:
masking a side of the quartz substrate with a first mask prior to the roughening, wherein the masked side is not roughened;
masking the side of the quartz substrate with a second mask prior to the coating, wherein the masked side is not coated; and
removing the second mask and cleaning the side of the quartz substrate with acetone after the coating is performed.

10. The article of claim 9, wherein the first mask is a hard mask, the second mask is a soft mask, and the masked side of the quartz substrate corresponds to an inner side of the quartz substrate.

11. The article of claim 8, wherein the ceramic coating has a thickness of approximately 1-12 mil prior to the polishing and a thickness of approximately 1-10 mil after the polishing.

12. The article of claim 8, wherein coating the quartz substrate comprises:
heating the quartz substrate to a temperature of approximately 10° C. to 300° C.; and
plasma spraying the quartz substrate using a plasma spray power of approximately 50 kW to 90 kW.

13. The article of claim 8, wherein the article is a protective ring for covering a portion of an electrostatic chuck used in a plasma etch reactor.

14. The article of claim 8, wherein the ceramic coating is selected from a list consisting of Y₂O₃, Y₃Al₅O₁₂ (YAG), and a compound comprising Y₄Al₂O₉ (YAM) and a solid solution of Y₂-xZrₓO₃

15. An article comprising:
a quartz substrate having a ring shape, the quartz substrate having a roughened surface with a roughness of approximately 100 micro-inches (μin) to approximately 300 μin; and
a ceramic coating on the roughened surface of the quartz substrate, wherein the ceramic coating comprises a yttrium containing oxide.

16. The article of claim 15, wherein:
the quartz substrate having the ring shape comprises an inner side, a top, a bottom and an outer side;
the top and the outer side have the roughened surface and the ceramic coating; and
the bottom and the inner side have an unroughened surface and lack the ceramic coating.

17. The article of claim 15, wherein the ceramic coating has a thickness of approximately 1-10 mil

18. The article of claim 15, wherein the article is a protective ring for covering a portion of an electrostatic chuck used in a plasma etch reactor.

19. The article of claim 15, wherein the ceramic coating is selected from a list consisting of Y₂O₃ and Y₃Al₅O₁₂ (YAG).

20. The article of claim 15, wherein the ceramic coating is composed of a compound comprising Y₄Al₂O₉ (YAM) and a solid solution of Y₂-xZrₓO₃
